(19) United States
(12) Patent Application Publication
(10) Pub. No.: US 2006/0150104 A1
(43) Pub. Date: Jul. 6, 2006

(54) Display of user selected digital artworks as embellishments of a graphical user interface

(76) Inventor: Luigi Lira, Costa Mesa, CA (US)

Correspondence Address: Luigi Lira, #198, 2973 Harbor Blvd, Costa Mesa, CA, 92626, US

(21) Appl. No.: 11/316,533

(22) Filed: Dec. 22, 2005

Related U.S. Application Data
(60) Provisional application No. 60/641,024, filed on Dec. 31, 2004.

(51) Int. Cl. G06F 9/00

(52) U.S. Cl. 715/733; 715/835; 715/810; 715/838; 715/764; 715/769

(57) ABSTRACT

The herewith described invention relates to the display of digital artworks, e.g. texts, graphics, images, animations, movies, or any combination of them, with or without sounds, as embellishments of a graphical user interface. More particularly, the invention relates to digital artworks that have been selected by a user to be displayed in association with a graphical user interface element, e.g. a window, a menu, or a control. Typically such association has the purpose of embellishing the look of the graphical user interface element. Typically such embellishments are not part of the data manipulated by the associated graphical user interface element, but in certain embodiments, the embellishment may be displayed, hidden, or, for example, graphically transformed upon the content of the manipulated data, i.e. the embellishment may be content sensitive.

### CROSS REFERENCE TO RELATED APPLICATIONS

This application claims priority to U.S. provisional patent application Ser. Nos. 60/641,024, filed 31 Dec. 2004, which application is incorporated herein in its entirety by this reference thereto.

This application also incorporates herein in its entirety by this reference thereto disclosure document No. 563,500, which was received at the U.S. Patent Office on 23 Oct. 2004.

### BACKGROUND OF THE INVENTION

1. Technical Field

This invention relates to graphical user interfaces for digital systems, e.g. personal computers, set-top boxes, and PDA's. More particularly, it relates to the display of digital artworks, e.g. texts, graphics, images, and animations, as embellishments of a graphical user interface. Such digital artworks are selected by a user to be displayed in association with a graphical user interface element, e.g. a window, a menu, a control, an icon, or a text caption.

2. Description of the Prior Art

The evolution of the computer industry is unparalleled in its rate of growth and complexity. Personal computers, for example, which began as little more than feeble calculators with limited memory, tape-driven input and monochrome displays are now able to tackle almost any data processing task. While this meteoric increase in power was almost sufficient to satisfy the demand of application programmers and end users alike, the corresponding increase in complexity created an ease-of-use problem that the industry was somewhat slower in solving. Thus, designers were faced with a new challenge: to harness this computing power in a form usable by even those with relatively little computer training to smooth the transition of other industries into a computer-based information paradigm.

As a result, in the early to mid-1980's many new I/O philosophies, such as “user friendly”, “WYSIWYG” and “menu driven” came to the forefront of the industry. These concepts are particularly applicable to microcomputers, also known as personal computers, which are intended to appeal to a broad audience of computer users, including those who previously feared and mistrusted computers. An important aspect of computers that employ these concepts was, and continues to be, the interface that allows the user to input commands and data and receive results, which is commonly referred to as a graphical user interface (GUI).

Nowadays the most common type of graphical user interface display is based on a visual metaphor which uses a display screen as a work surface called a “desktop” where documents are presented in relocatable regions termed “windows”. The user interacts with the computer by, for example, moving objects on the desktop, choosing commands from menus, and manipulating window controls, such as checkboxes and scroll bars. The use of personal computers has become so ubiquitous that most people are already familiar with the basic concepts of this type of graphical user interface, and just a brief depiction of an exemplary graphical user interface should herein suffice. In addition, this type of graphical user interface has been very successful and it has also been adopted outside personal computers, for example, for PDA's, set-top boxes, game consoles, and advanced cellphones.

FIG. 3A provides an example of a prior art graphical user interface 10, an Apple Macintosh OS X graphical user interface, wherein some typical graphical user interface elements are displayed such as a menu bar 300, an open menu 310, a dock 320, a window 110 implementing a calculator interface, a window 120 implementing a word processor interface, a window 130 implementing the Finder interface, and the window 140 implementing a spreadsheet interface.

The look and feel of a particular graphical user interface is of great relevance for a consumer chooses a particular brand of operating system, e.g. Apple OS X, Microsoft Windows, or Linux, also based on the look and feel of its graphical user interface. Also, within an operating system, different software providers use the look and feel of an application graphical user interface as a key feature to compete with each other, for example, America Online AIM instant messaging, Yahoo instant messaging, and Microsoft MSN instant messaging have similar features and present very colorful and entertaining graphical user interfaces to entice a user to use its services versus the services of a competitor. Hence, the long quest by software companies to improve on the graphical user interface.

As shown by Craycroft in U.S. Pat. No. 5,692,142 and 5,838,315, one method to improve on a graphical user interface is to allow applications to have access to window frames look and behavior, e.g. creating custom looking window frames with custom controls in them. Similarly Johnston et al. in U.S. Pat. No. 5,880,729 show how an operating system can enhance the look and feel of controls (e.g. buttons and checkboxes) by displaying transitory states (e.g. a button animates the transition from selected to deselected).

Again Johnston et al. in U.S. Pat. No. 5,959,624 and Voas in U.S. Pat. No. 6,188,399 show how an operating system can provide a plurality of graphical user interface designs for graphical user interface elements, and how to allow a user to select from them. In U.S. Pat. No. 6,731,310 again Craycroft et al. show how an operating system can employ graphical user interface themes to enhance its look and feel.

Lastly, Chew et al. in U.S. Pat. No. 5,990,905 show how an operating system can provide child windows to enhance the look and feel of its graphical user interface, and Brown et al. in U.S. Pat. No. 6,954,905 show how to enhance the functionality and the look of a graphical user interface by displaying transparency characteristic aids.

### SUMMARY OF THE INVENTION

The herewith described invention relates to the display of digital artworks, e.g. texts, graphics, images, animations, movies, or any combination of them, with or without sounds, as embellishments of a graphical user interface. More particularly, the invention relates to digital artworks that have been selected by a user to be displayed in association with a graphical user interface element, e.g. a window, a menu, or a control. Typically such association has the purpose of embellishing the look of the graphical user interface element. Typically such embellishments are not part of the data manipulated by the associated graphical user interface element, but in certain embodiments, the embellishment may be displayed, hidden, or, for example, graphically transformed upon the content of the manipulated data, i.e. the embellishment may be content sensitive.

FIG. 1A is an example of a prior art depicting an application window 100, an instant messenger session window. FIG. 1B is an example of the same application window 100, an instant messenger session window, embellished with digital artworks selected by a user. Typically a user selects a digital artwork to become an embellishment to personalize and customize to his/her taste the look of a graphical user interface element, in this case a window. The flowchart of FIG. 2 is an example of a sequence of operations involving the selection of at least one digital artwork, the selection of at least one graphical user interface element, and the association of the at least one digital artwork with the at least one graphical user interface element.

Although digital artworks have been used and displayed within a graphical user interface since the early days of graphical user interfaces such digital artworks have been displayed either as part of a preset graphical user interface or as part of data manipulated by an application, for example, a picture belonging to a word processor document, an image displayed within a graphical user interface of an instant messaging application used to project a user personality (e.g. a so called avatar or a wallpaper), or a preview of a graphic file in a desktop viewer application. Embellishments, on the other hand, are digital artworks that freely embellish specific graphical user interface elements selected by a user, thus extending the look and feel of a graphical user interface to match the custom taste of each user.

FIG. 3A provides an example of a prior art graphical user interface 10, an Apple Macintosh OS X graphical user interface, wherein some typical graphical user interface elements are displayed. FIG. 3B is an example of the same graphical user interface embellished with digital artworks selected by a user. Embellishments allow the user a great level of customization of the graphical user interface. Typically different embellishments are associated with different windows to provide each window with a unique look or a distinguishing attribute.

In one embodiment, the overall experience perceived by a user is that an embellishment seems to be “bonded” to a graphical user interface element, e.g. a menu or a window. The embellishment will, for example, appear, disappear, move, and behave following the graphical user interface element, for example, appearance, disappearance, movement, and behavior. An analogy for the real world would be, for example, a magazine photo taped on the cover of a school book: when the school book is used by the student and lays on the desk, then the taped photo is visible, when the book is stored away, then the taped photo is out of sight as well.

Typically an embellishment is not part of the data manipulated by an application, meaning that, typically, the embellishment data does not belong with the data that the application is set to manipulate. For example, a word processor application is set to manipulate text and images contained in a document, but an embellishment displayed to adorn the window displaying such document is not part of the document data itself. Although, eventually, when the concept of embellishing becomes commonplace and the word processor application is modified to support embellishments at application level, the word processor application might store the embellishment data along with the document data as a matter of convenience. This concept is more clearly understandable using the calculator 110 of FIG. 3B as an example. The calculator is set to manipulate numbers, which is the function of the calculator and the reason for a user to use it. The embellishments 111, a sun, and 112, a flower are not part of the data manipulated by the calculator. The embellishments 111, a sun, and 112, a flower have been subsequently associated with the calculator primarily for aesthetic reasons.

In one embodiment, an embellishment may be displayed as a cut-out image. A cut-out image is herewith defined as an image which contour follows the shape of the image itself instead of being merely, for example, rectangular. FIG. 3B depicts some examples of cut-out images, which are, among others, embellishments 111, a sun, 112, a flower, 311, a rubber duck, and 122 a leaf. Displaying an embellishment as a cut-out image is of particular importance because it enhances the look and feel of the embellishment. As it is noticeable in FIG. 4A, an embellishment wherein the image is not cut-out, such as, among others, embellishments 154, kissing lips, and 155, a thumb up, does not provide the same aesthetically pleasant integration with the application graphical user interface.

Also depicted in FIG. 3B is another key feature for an embellishment, which is: being placed only partially overlaid, or underlaid, on an application graphical user interface as depicted, among others, by embellishments 111, a sun, 311, a rubber duck, 122 a leaf, instead of the embellishment being merely displayed within the graphical user interface as exemplified in FIG. 4B by, among others, embellishments 151, a rose, and 152, an airplane.

Such peculiar embellishment placement (i.e. the embellishment is placed only partially overlaid, or underlaid, on an application graphical user interface) clearly marks an association between a graphical user interface element (e.g. window 110 of FIG. 3B) and the embellishment (e.g. embellishment 111, a sun, of FIG. 3B) and at the same time only minimally obstructs the display of the graphical user interface element itself.

Typically, an embellishment is associated with a graphical user interface element, e.g. a window, without limit of time, and it survives the disposing of the graphical user interface element, e.g. the closing of the window. In other words, when such graphical user interface element is redisplayed, e.g. the window is reopened, the associated embellishment is redisplayed. Typically, an embellishment is associated with a graphical user interface element until a user chooses to break the association between the embellishment and the graphical user interface element.

In one embodiment, a user may exchange with at least one recipient user an embellishment by performing such operation from within a graphical user interface that a software able to handle embellishments may provide, without requiring the user to employ a separate communication application (e.g. an e-mail client application or an instant messenger application) to exchange the embellishment.

### BRIEF DESCRIPTION OF THE DRAWINGS

FIGS. 1A and 1B provide examples of an instant messenger session window with and without embellishments;

FIG. 2 is a flowchart providing an example of selection and association of an embellishment;

FIG. 3A provides an example of a prior art graphical user interface;

FIG. 3B provides an example of a graphical user interface with embellishments;

FIGS. 4A and 4B provide examples of an instant messenger session window with embellishments;

FIG. 5 provides an example of an e-mail application window with embellishments;

FIG. 6 provides an example of a web browser application window with embellishments;

FIGS. 7A and 7B provide examples of a music application window with and without embellishments;

FIGS. 8A, 8B, and 8C provide examples of a spreadsheet window with and without embellishments;

FIG. 9 provides an example of a graphical user interface with embellishments;

FIGS. 10A and 10B provide examples of an embellishment repositioning during the associated window repositioning;

FIGS. 11A, 11B, and 11C provide an example of an embellishment transitioning into an alternate form; and

FIG. 12 is a flowchart providing an example of selection and delivery of an embellishment.

### DETAILED DESCRIPTION OF THE INVENTION

The herewith described invention relates to the display of digital artworks, e.g. texts, graphics, images, animations, movies, or any combination of them, with or without sounds, as embellishments of a graphical user interface. More particularly, the invention relates to digital artworks that have been selected by a user to be displayed in association with a graphical user interface element, e.g. a window, a menu, or a control. Typically such association has the purpose of embellishing the look of the graphical user interface element. Typically such embellishments are not part of the data manipulated by the associated graphical user interface element, but in certain embodiments, the embellishment may be displayed, hidden, or, for example, graphically transformed upon the content of the manipulated data, i.e. the embellishment may be content sensitive.

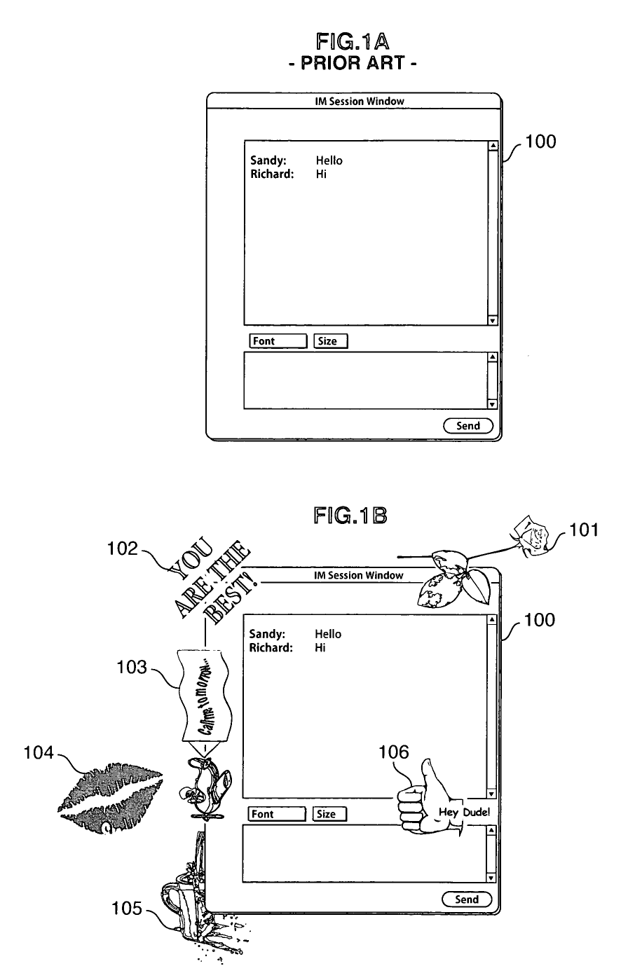

FIG. 1A is an example of a prior art depicting an application window 100, an instant messenger session window. FIG. 1B is an example of the same application window 100, an instant messenger session window, embellished with digital artworks selected by a user. Typically a user selects a digital artwork to become an embellishment to personalize and customize to his/her taste the look of a graphical user interface element, in this case a window.

In one embodiment, an embellishment may be associated with, for example, at least one window. The digital artwork 101, a rose, is an embellishment. A digital system, for example, automatically or upon request by a user, instructs a software (e.g. the application to which the window 100 belongs, an operating system, or a software related to the application or to the operating system) to associate the embellishment 101 to the window 100. The embellishment 101 is displayed overlaid to the window 100 and is associated with it. The embellishment 101 will behave so as to be perceived by the user as having been “bonded”, loosely bonded, or otherwise attached to the window 100, e.g. it follows the window movement, layering position, appearance, and disappearance.

Similarly, the embellishment 102, some text, 103, an airplane, and 106, a thumb up, are displayed overlaid to the window 100 and are associated with it. The embellishment 104, kissing lips, is close but it is not overlapping the window 100, yet is associated with the window 100. Finally, the embellishment 105, a coffee mug, is underlaid to the window 100 and is associated with it. All the embellishments 101, 102, 103, 104, 105, and 106 will behave so as to be perceived by the user as having been “bonded”, loosely bonded, or otherwise attached to the window, e.g. they follow the window movement, layering position, appearance, and disappearance.

The digital artwork used as embellishment for the window 100, an instant messenger session window, may have been exchanged during an instant messaging communication. For example, the user may have received such digital artwork from a second user and chosen to attach the digital artwork as embellishment to the instant messenger session window to have a reminder of a pleasant conversation. Alternatively, the user may have selected the embellishment from another source, e.g. a web page or a CD-ROM.

One embodiment might provide a user with, for example, a contextual menu to select which digital artwork should be used to embellish a graphical user interface element, e.g. a window or a menu. For example, the user might right-click on a window to open a contextual menu to select a digital artwork to be displayed as an embellishment for the window. Another embodiment might provide the user with a drag-and-drop feature capable to attach a digital artwork as embellishment to a graphical user interface element, e.g. a window or a menu. For example, the user might drag a digital artwork to a preselected area of a window and drop it, which results in the digital artwork being attached to the window as an embellishment.

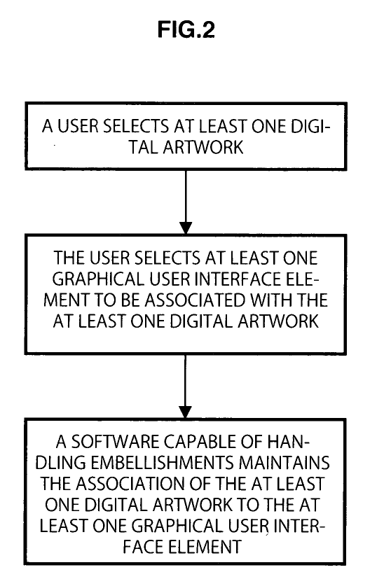

The flowchart of FIG. 2 is an example of a sequence of operations involving the selection of at least one digital artwork, the selection of at least one graphical user interface element, and the association of the at least one digital artwork with the at least one graphical user interface element. In one alternative embodiment, the selection of the at least one graphical user interface element may be performed before the selection of the at least one digital artwork.

Although digital artworks have been used and displayed within a graphical user interface since the early days of graphical user interfaces such digital artworks have been displayed either as part of a preset graphical user interface or as part of data manipulated by an application, for example, a picture belonging to a word processor document, an image displayed within a graphical user interface of an instant messaging application used to project a user personality (e.g. a so called avatar or a wallpaper), or a preview of a graphic file in a desktop viewer application. Embellishments, on the other hand, are digital artworks that freely embellish specific graphical user interface elements selected by a user, thus extending the look and feel of a graphical user interface to match the custom taste of each user.

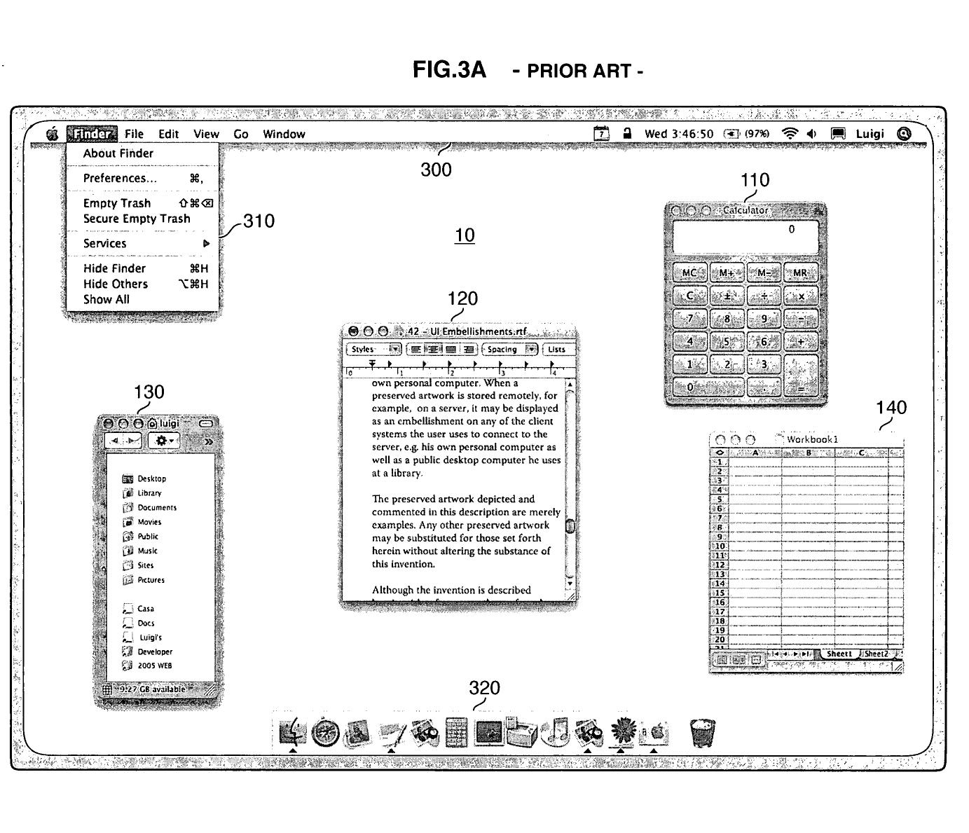

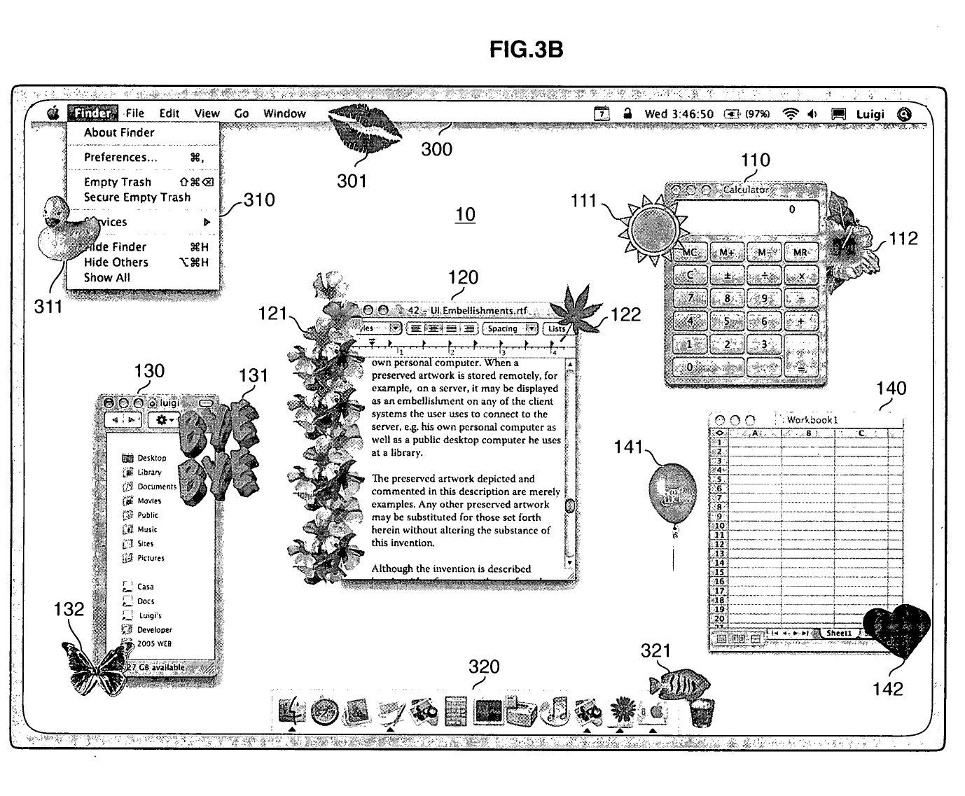

FIG. 3A provides an example of a prior art graphical user interface 10, an Apple Macintosh OS X graphical user interface, wherein some typical graphical user interface elements are displayed such as a menu bar 300, an open menu 310, a dock 320, a window 110 implementing a calculator interface, a window 120 implementing a word processor interface, a window 130 implementing the Finder interface, and the window 140 implementing a spreadsheet interface.

FIG. 3B is an example of the same graphical user interface embellished with digital artworks selected by a user. Embellishments allow the user a great level of customization of the graphical user interface. Typically different embellishments are associated with different windows to provide each window with a unique look or a distinguishing attribute.

In this embodiment, the embellishment 301, kissing lips, is associated with the menu bar 300 of the Finder application. When the Finder is the forefront application, its menu bar becomes visible and so does the embellishment 301, kissing lips, that is associated with the Finder menu bar 300. When another application is in the forefront, then the Finder menu bar 300 will no longer be displayed, and the embellishment 301, kissing lips, will no longer be displayed either. The embellishment 311, a rubber duck, is associated with the menu “Finder” 310 of the Finder application. When the menu “Finder” 310 is displayed, the associated embellishment 311, a rubber duck, is also displayed. When the menu “Finder” 310 is no longer displayed, the associated embellishment 311, a rubber duck, for example, is no longer displayed or becomes altered in its content or display. Similarly, the embellishment 321, a fish, is associated with the system dock 320. When the system dock 320 is displayed, the associated embellishment 321, a fish, is also displayed. When the system dock 320 is hidden, the associated embellishment 321, a fish, for example, is hidden or becomes altered in its content or display.

In one embodiment, the overall experience perceived by a user is that an embellishment seems to be “bonded” to a graphical user interface element, e.g. a menu or a window. The embellishment will, for example, appear, disappear, move, and behave following the graphical user interface element, for example, appearance, disappearance, movement, and behavior. An analogy for the real world would be, for example, a magazine photo taped on the cover of a school book: when the school book is used by the student and lays on the desk, then the taped photo is visible, when the book is stored away, then the taped photo is out of sight as well.

Referring again to FIG. 3B, the embellishment 111, a sun, is associated with the window 110, a calculator. When the window 110, a calculator, is displayed, also the associated embellishment 111, a sun, is displayed. When the window 110, a calculator, is no longer displayed, also the associated embellishment 111 is no longer displayed. In addition, when the window 110 is repositioned on the screen, for example, the window moves from one coordinate to another dragged by a user, the embellishment 111 repositions with it. For example, the embellishment 111 might move in real time with the window 110 so as to be perceived by the user as being “one entity” with the window 110, it might follow the window 110 with a delay so as to be perceived as “trying to catch up with the window movements”, or reposition only at the end of the repositioning of the window 111 so as to be perceived as to “jump” to the new position. Similarly the embellishment 112, a flower, is also associated with the window 110, a calculator. In this case the embellishment is displayed as to be perceived being layered underneath the window 110. As for any typical embellishment, it will behave in accordance with the behavior of the associated window, e.g. appear, disappear, move, and layer reposition.

The embellishment 121, flowers, is associated with the window 120, a word processor. As for any typical embellishment, it will behave in accordance with the behavior of the associated window, e.g. appear, disappear, move, and layer reposition. In addition, the embellishment 121 is composed of several digital artworks depicting flowers, and it will expand or shrink, e.g. it gets longer or shorter, to match the size of the associated window 120. When the window 120 is resized on the screen, for example, when the window resizes following a user dragging the window's grow box (typically the bottom right portion of a window), the embellishment 121 resizes with it. For example, the embellishment 121 might resize in real time with the window 120 so as to be perceived by the user as being “one entity” with the window 120, it might resize with the window 120 with a delay so as to be perceived as “trying to catch up with the window resizing”, or resize only at the end of the resizing of the window 121 so as to be perceived as to “pop” to the new size. The window 120 has also a second embellishment 122, a leaf, associated with it.

In one embodiment, an embellishment may be displayed as a cornice to a graphical user interface element, e.g. a window. For example, the embellishment 121, flowers, associated with the window 120, a word processor, may extend to cover all four sides of the window 120 (not shown in the figure). Also, an embellishment may cover or be in proximity of at least a part of at least one side or corner of a graphical user interface element.

The embellishment 131, some text, is associated with the window 130, a Finder window. As for any typical embellishment, it will behave in accordance with the behavior of the associated window. Also, the embellishment 132, a butterfly, is associated with the window 130, a Finder window. As for any typical embellishment, it will behave in accordance with the behavior of the associated window. In addition, the embellishment 132 will reposition relative to the window 130 when the window 130 resizes, so to be always positioned near the bottom left portion of the window 130. Furthermore the embellishment 132 might display an animation, e.g. flap its wings, in response to a user action, e.g. the resizing or repositioning of the window 130, or when a predetermined time interval expires.

The embellishment 141, a balloon, is associated with the window 140, a spreadsheet. As for any typical embellishment, it will behave in accordance with the behavior of the associated window. In this case, the embellishment is displayed to be perceived as being at a distance from the window 140. Also, the embellishment 142, a heart, is associated with the window 140, a spreadsheet. As for any typical embellishment, it will behave in accordance with the behavior of the associated window. In addition, the embellishment 142 will reposition relative to the window 140 when the window 140 resizes, so as to be always positioned near the bottom right portion of the window 140.

In one embodiment, an embellishment may be displayed as a cut-out image. A cut-out image is herewith defined as an image which contour follows the shape of the image itself instead of being merely, for example, rectangular. A cut-out image may be achieved, for example, by employing an alpha channel or by using a clipping path. FIG. 3B depicts some examples of cut-out images, which are, among others, embellishments 111, a sun, 112, a flower, 311, a rubber duck, and 122 a leaf.

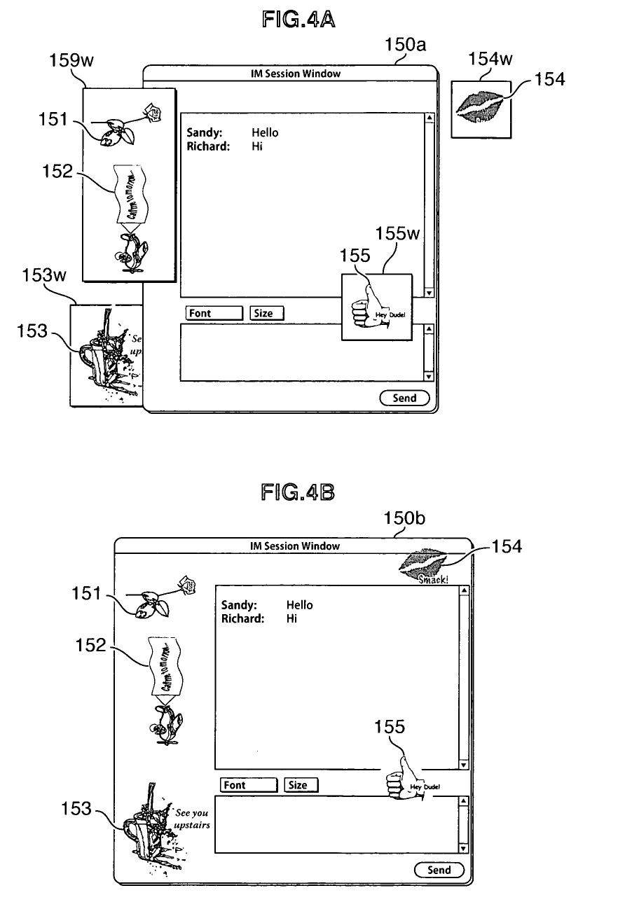

Displaying an embellishment as a cut-out image is of particular importance because it enhances the look and feel of the embellishment. As it is noticeable in FIG. 4A, an embellishment wherein the image is not cut-out, such as, among others, embellishments 154, kissing lips, and 155, a thumb up, does not provide the same aesthetically pleasant integration with the application graphical user interface.

Also depicted in FIG. 3B is another key feature for an embellishment, which is: being placed only partially overlaid, or underlaid, on an application graphical user interface as depicted, among others, by embellishments 111, a sun, 311, a rubber duck, 122 a leaf, instead of the embellishment being merely displayed within the graphical user interface as exemplified in FIG. 4B by, among others, embellishments 151, a rose, and 152, an airplane.

Such peculiar embellishment placement (i.e. the embellishment is placed only partially overlaid, or underlaid, on an application graphical user interface) clearly marks an association between a graphical user interface element (e.g. window 110 of FIG. 3B) and the embellishment (e.g. embellishment 111, a sun, of FIG. 3B) and at the same time only minimally obstructs the display of the graphical user interface element itself.

Typically, an embellishment is associated with a graphical user interface element, e.g. a window, without limit of time, and it survives the disposing of the graphical user interface element, e.g. the closing of the window. In other words, when such graphical user interface element is redisplayed, e.g. the window is reopened, the associated embellishment is redisplayed. Typically, an embellishment is associated with a graphical user interface element until a user chooses to break the association between the embellishment and the graphical user interface element.

Typically an embellishment is not part of the data manipulated by an application, meaning that, typically, the embellishment data does not belong with the data that the application is set to manipulate. For example, a word processor application is set to manipulate text and images contained in a document, but an embellishment displayed to adorn the window displaying such document is not part of the document data itself. Although, eventually, when the concept of embellishing becomes commonplace and the word processor application is modified to support embellishments at application level, the word processor application might store the embellishment data along with the document data as a matter of convenience. This concept is more clearly understandable using the calculator 110 of FIG. 3B as an example. The calculator is set to manipulate numbers, which is the function of the calculator and the reason for a user to use it. The embellishments 111, a sun, and 112, a flower are not part of the data manipulated by the calculator. The embellishments 111, a sun, and 112, a flower have been subsequently associated with the calculator primarily for aesthetic reasons.

In one embodiment, an embellishment may, for example, become animated from time to time (e.g. a dog that barks every minute, a flower that blossom in the morning, etc.), change shape, content, or position from time to time (e.g. every day, from day to night, etc.), move or reposition from one side of a graphical user interface element to another side, become animated on user action (e.g. on a click, on a double click, on a keystroke, etc.), perform a rollover (i.e. animates or changes content when the mouse pointer passes over it), and become animated on application or system action (e.g. it animates when a window opens, it animates when new mail arrives, etc.).

In one embodiment, an embellishment may, for example, play a sound or produce speech when a preset amount of time expires (e.g. a clock that produces a chime every hour, a bird that sing in the morning, etc.), upon user action (e.g. a mouse movement, a click, a double click, a keystroke, etc.), or upon application or system action (e.g. when a window opens, when new mail arrives, etc.).

In one embodiment, an embellishment may change appearance upon network data input. For example, an embellishment may display the current weather for a city, and upon current weather condition, retrieved by means of a network connection, displays either a sun, a cloud, a rain shower, etc. Another example would be an embellishment displaying a live picture from a webcam (e.g. a video camera transmitting live images over the Internet).

In one embodiment, a user may select an embellishment, for example, from a local repository (e.g. a local folder) or from a remote repository (e.g. a web-site). Also, an embellishment may be made available in exchange for payment (e.g. a fee is levied to allow an embellishment to be downloaded or displayed).

In one embodiment, an embellishment associated with a graphical user interface element may be automatically repositioned or altered, for example, when a new embellishment becomes associated with the same graphical user interface element, with another graphical user interface element, or when the graphical user interface element changes size, shape, or position.

In one embodiment, a user is allowed to select, for example, the size, orientation, transparency, and digital elaboration (e.g. a digital image filter to drop a shadow beneath the digital artwork) of an embellishment. Also, the user may be allowed to temporarily hide an embellishment (e.g. for the purpose to have an unobstructed view of a document).

FIG. 4A is an example of a window 150a, an instant messenger session window, embellished with digital artworks displayed within container windows. Certain operating systems might have limitations in displaying digital artworks in non-rectangular windows (e.g. as independent buffered alpha channel windows). In the embodiment exemplified in FIG. 4A, the embellishments are displayed within overlaid and underlaid rectangular windows. Embellishments 151, a rose, and 152, an airplane, are associated with the window 150a, an instant messenger, and are displayed within the container window 159w, which is overlaid to the window 150a. The embellishment 153, a coffee mug, is also associated with the window 150a and is displayed within the container window 153w, which is underlaid to the window 150a. The embellishment 154, kissing lips, is associated with the window 150a and is displayed within the container window 154w, which is placed aside the window 150a. The embellishment 155, a thumb up, is associated with the window 150a and is displayed within the container window 155w, which is placed overlaid within the window 150a. As for any typical embellishment, they and their container windows will behave in accordance with the behavior of the associated window, e.g. appear, disappear, move, and layer reposition. Further embodiments might present embellishments, for example, within windows that have other than rectangular shapes (e.g. they might be oval shaped, polygonally shaped, or shaped in straight-lines and curved-lines) or that have semi-transparent content or background.

FIG. 4B is an example of a window 150b, an instant messenger session window, embellished with digital artworks displayed within the window 150b itself. In the embodiment exemplified in FIG. 4B, the embellishments are drawn within the associated window itself, for example, they are drawn using the same operating system graphic function used to draw regular content for the window 150b (e.g. texts, images, and controls). Embellishments 151, a rose, 152, an airplane, 153, a coffee mug, 154, kissing lips, and 155, a thumb up, are associated with the window 150b, an instant messenger, and are displayed within the window 150b itself. As for any typical embellishment, they will behave in accordance with the behavior of the associated window, e.g. appear, disappear, move, and layer reposition.

In one embodiment, the association of an embellishment with a graphical user interface element may be content sensitive. In other words, the embellishment may be displayed along with an element when the element is, for example, handling or displaying specific data and not just any data. For example, having an e-mail client application displaying a window wherein a pane is displaying an e-mail, an embellishment may be associated with the pane displaying an e-mail from a specific sender. In other words, when the pane is displaying an e-mail from such sender, the embellishment is displayed too, but when the pane is displaying an e-mail from any other sender, then the embellishment is, for example, not displayed or altered in its content or display.

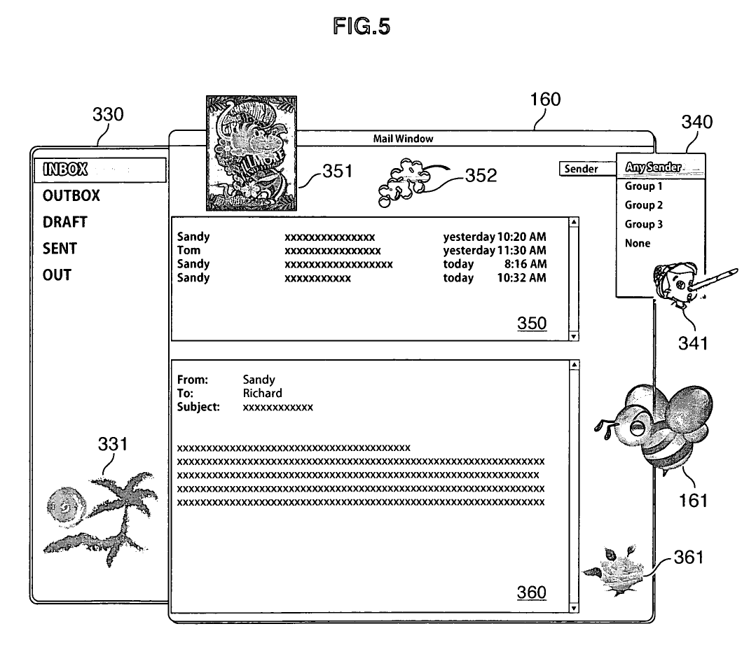

FIG. 5 provides an example of an e-mail window 160 with several embellishments. In this embodiment, an embellishment may be associated with, for example, at least one part of window content. The embellishment 331, a palm with sea and sun, is associated with the mailbox pane 330 and is displayed to the user only when the mailbox pane is open (i.e. made visible). The embellishments 351, a film poster, and 352, a grapevine, are associated with the INBOX mailbox, and are, for example, displayed only when the INBOX mailbox is displayed in the window pane 350. When another mailbox is displayed in the window pane 350 (e.g. an OUTBOX mailbox), for example, another set of embellishment may be displayed in place of the embellishments 351 and 352. The embellishment 161, a bee, is associated with the whole window 160 and is displayed when the window is open.

The embellishment 361, a rose, is associated with one, and only one, sender. In the example, such sender is “Sandy” (i.e. a sender whose username is Sandy.) The embellishment 361 is displayed, for example, only when an e-mail from “Sandy” is displayed in the pane 360. When an e-mail from another sender is displayed in the pane 360, for example, another set of embellishments may be displayed in place of the embellishment associated with “Sandy”. The embellishment 341, Pinocchio, is associated with the popup menu 340, and is displayed each time and only when the popup menu 340 is selected.

In one embodiment, the association between an embellishment and a sender may be established upon input from the digital system, for example, as result of an automatic process or as result of a request from a user. For example, after the user receives from a sender an e-mail containing a digital artwork, e.g. a greeting card or a picture, he may choose to preserve the digital artwork and have it displayed as an embellishment for the e-mail window. Furthermore, he may choose to have such embellishment be associated with such sender only. Such embellishment, e.g. embellishments 361, for example, will be displayed every time the pane 360 is displaying any e-mail from such sender. Such embellishment, for example, will be displayed only while the pane 360 is displaying an e-mail from such sender, when the pane 360 is displaying an e-mail from any other sender, such embellishment, for example, will not be displayed.

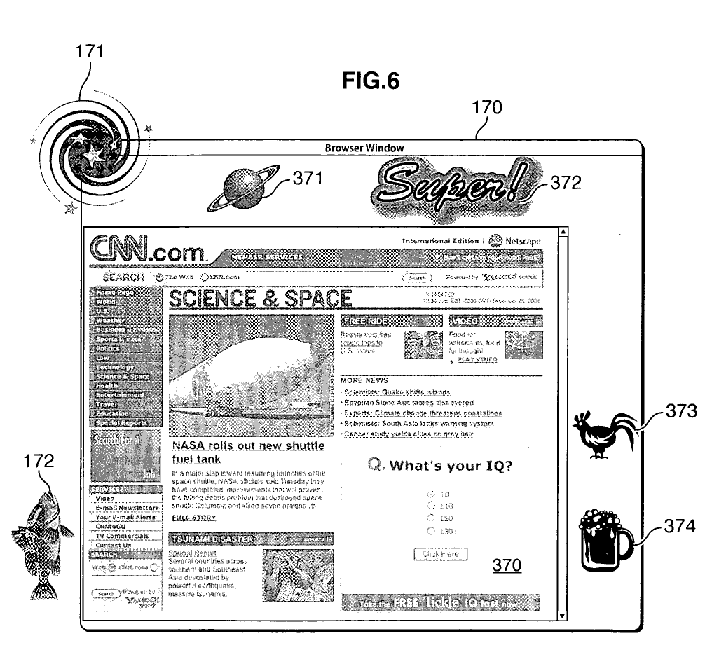

FIG. 6 provides an example of web browser window 170 with several embellishments. In this embodiment, the embellishments 171, a galaxy draw, and 172, a fish, are associated with the window 170 and are displayed when the window is open. The embellishments 371, a Saturn draw, 372, some text, 373, a rooster, and 374, a beer mug, are associated with only one web-site (e.g. the CNN web-site) and are, for example, displayed only when a page from such web-site (e.g. the CNN web-site) is displayed in the pane 370. When a page from another web-site is displayed in the pane 370, for example, another set of embellishments may be displayed in place of the embellishments 371, 372, 373, and 374 that are associated only with such specified web-site (e.g. the CNN web-site).

In one embodiment, the association between an embellishment and a web-site is established upon input from the digital system, for example, as result of an automatic process or as result of a request from the user. For example, after the user views a page of a web-site containing a digital artwork, e.g. a graphic or a picture, he may choose to preserve the digital artwork and to have an instance of it displayed as an embellishment of the web browser window. Furthermore, he may choose to have such embellishment be associated only with such web-site. Such embellishment, e.g. embellishments 371, for example, will be displayed every time the pane 370 is displaying any page from such web-site. Such embellishment, for example, will be displayed only while the pane 370 is displaying a page from such web-site; when the pane 370 is displaying a page from any other web-site, such embellishment, e.g. embellishments 371, for example, will not be displayed.

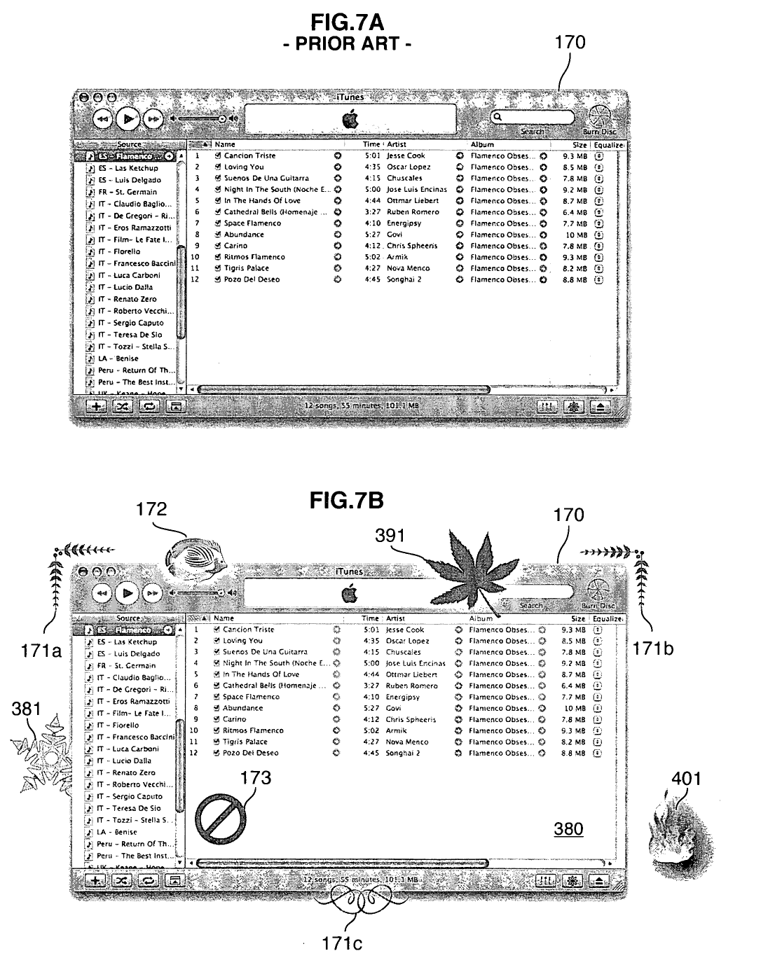

FIG. 7A is an example of a prior art depicting a window 170, a music application window. FIG. 7B is an example of the same window 170, a music application window, embellished with digital artworks selected by a user. Typically a user selects a digital artwork to become an embellishment with the purpose to personalize and customize to his/her taste the look of a graphical user interface element, in this case a window.

In one embodiment, an embellishment may comprise a multitude of digital artworks. I the example of FIG. 7B, the digital artworks 171a, 171b, and 171c, ornaments, are parts of the same embellishment associated with the window 170. When the window 170 changes size, the digital artworks 171a, 171b, and 171c, which belongs to the same embellishment, will reposition to maintain their relative position to the window 170 borders. The embellishments 172, a fish, and 171, an underground sign, are also associated with the window 170. The embellishments 381, a snow flake, is associated with the “Flamenco” playlist, and, for example, is displayed only when the “Flamenco” playlist is displayed in the window pane 380. When another playlist is displayed in the window pane 380 (e.g. a “Jazz” playlist), for example, another set of embellishments may be displayed in place of the embellishment 381.

The embellishment 391, a leaf, is associated with the application status “music on”. The embellishment 391, for example, is displayed when the music application is playing music. When the music application is playing no music, for example, the embellishment is hidden. The embellishment 401, a flame, is associated with the music application itself. The embellishment 401 is displayed when the music application is running (i.e. is currently part of the software executed by the operating system). When the music application is not running, the embellishment, for example, is hidden.

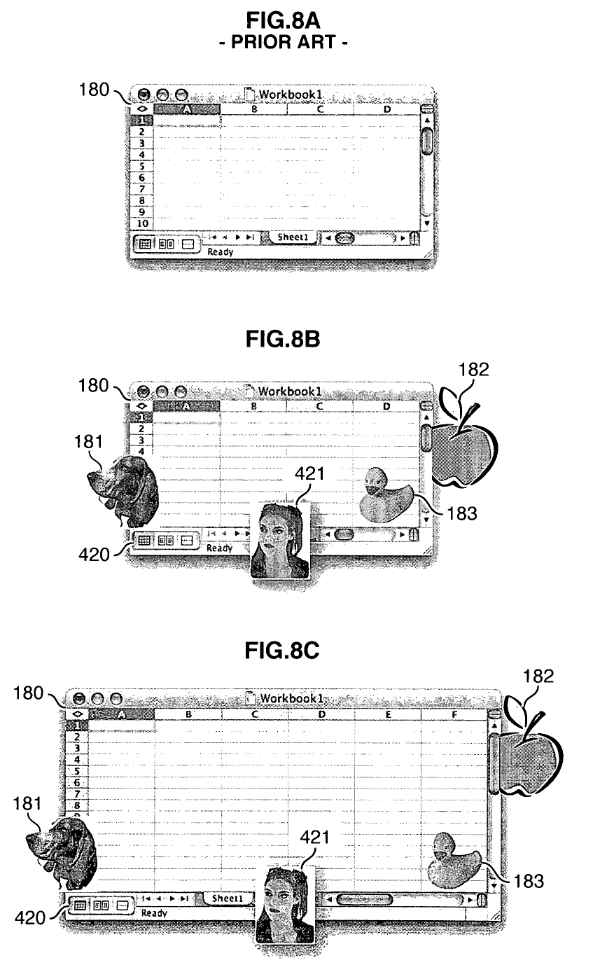

FIG. 8A is an example of a prior art depicting a window 180, a spreadsheet window. FIG. 8B is an example of the same window 180, a spreadsheet window, embellished with digital artworks selected by a user. FIG. 8C is an example of the same window 180, a spreadsheet window, embellished with digital artworks after it has been resized by a user.

Referring to FIG. 8B, the embellishments 181, a dog, 182, an apple, and 183, a rubber duck, are associated with the window 180. The embellishment 421, a photo of a young woman, is associated with the spreadsheet view button 420. When the view button 420 is selecting “Normal view” (i.e. the leftmost icon of the trio is selected), then the embellishment 421, a photo of a young woman, is displayed. When view button 420 is selecting any other view type, the embellishment 421 is, for example, not displayed or altered in its content or display.

In the example provided by FIG. 8C, the window 180 has been resized. It is noticeable that the embellishments 181, 182, 183 and 421, are repositioned to maintain their relative position to the window 180 borders and corners constant. The embellishment 181, a dog, remains close to the bottom left corner, the embellishment 182, an apple, remains close to the upper right corner, the embellishment 183, a rubber duck, remains close to the bottom right corner, and the embellishment 421, a photo of a young woman, remains in the middle of the bottom border.

One embodiment might, for example, allow a user to select the repositioning rules for an embellishment (e.g. to what corner or border of the associated window the embellishment should maintain constant distance). Another embodiment might, for example, provide only preset rules for embellishment repositioning (e.g. an embellishment always “stick” to its closest corner). Also, one embodiment might support further rules, for example, when two embellishments become too close after a window change of size, then one, or both, might be hidden, reduced in side, or otherwise transformed to maintain an aesthetically pleasant look for the window and the embellishments.

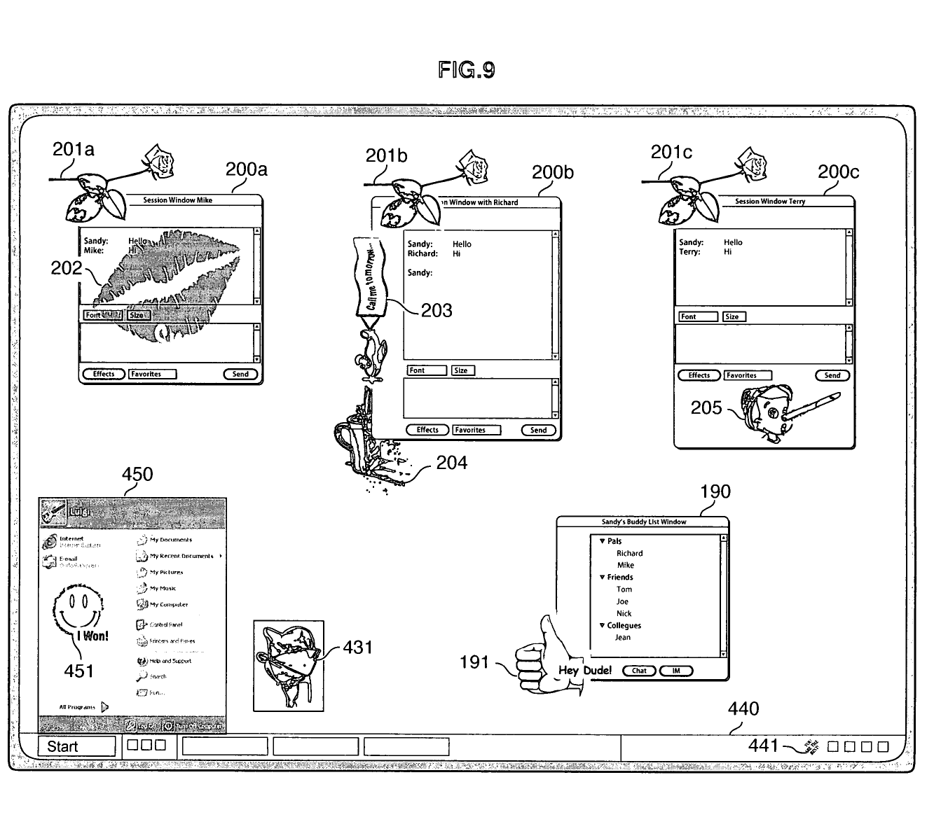

In one embodiment, an embellishment may be associated with, for example, a plurality of windows, e.g. all session windows of an instant message application. In such case the embellishment will be displayed in multiple instances. FIG. 9 is an example of graphical user interface embellished with digital artworks selected by a user. The embellishment that is displayed in the three instances 201a, 201b, and 201c, a rose, is associated with all session windows (session window 200a, 200b, and 200c are shown in the example). An instance of the embellishment is displayed with, and attached to, any session window of the instant messenger application.

In one embodiment, an embellishment may be also associated with the content of a window, for example, a session window of an instant message application used to communicate with one specific recipient (e.g. used to communicate with the recipient “Richard”). In the example of FIG. 9, the embellishment 202, kissing lips, is associated with the recipient “Mike” (i.e. a recipient whose username is Mike), and it is displayed with and attached to the “Mike” session window 200a. The embellishments 203, an airplane, and 204, a coffee mug, are associated with the recipient “Richard” (i.e. a recipient whose username is Richard), and they are displayed with and attached to the “Richard” session window 200b. The embellishment 205, Pinocchio, is associated with the recipient “Terry” (i.e. a recipient whose username is Terry), and is displayed with and attached to the “Terry” session window 200c.

The embellishment 191, a thumb up, is associated with the buddy list window 190, which is part of the instant messenger application. The embellishment 191 is displayed with and attached to the buddy list window 190 of the instant messenger application. The embellishment 431, a rose bud, is associated with the instant messenger application itself. The embellishment is displayed when the instant messenger application is active. The embellishment 441, a phrase, is associated with the task bar 440. The embellishment is displayed when the task bar is visible. The embellishment 451, a smiley, is associated with the start menu 450. The embellishment 451 is displayed when the start menu 450 is open.

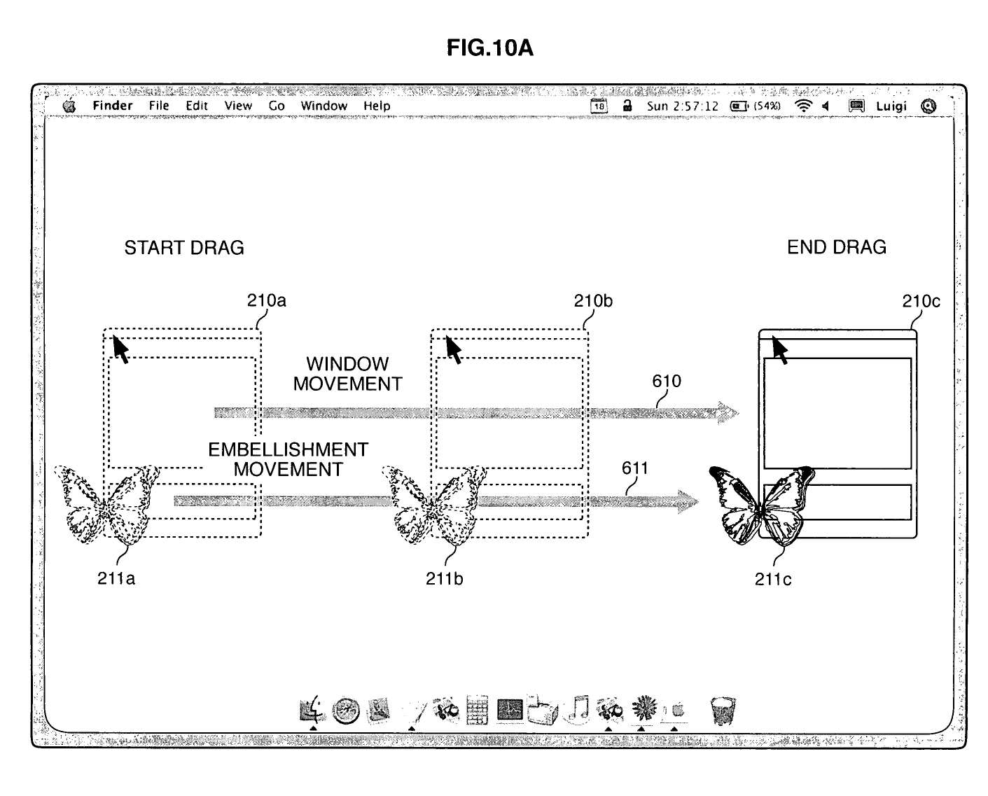

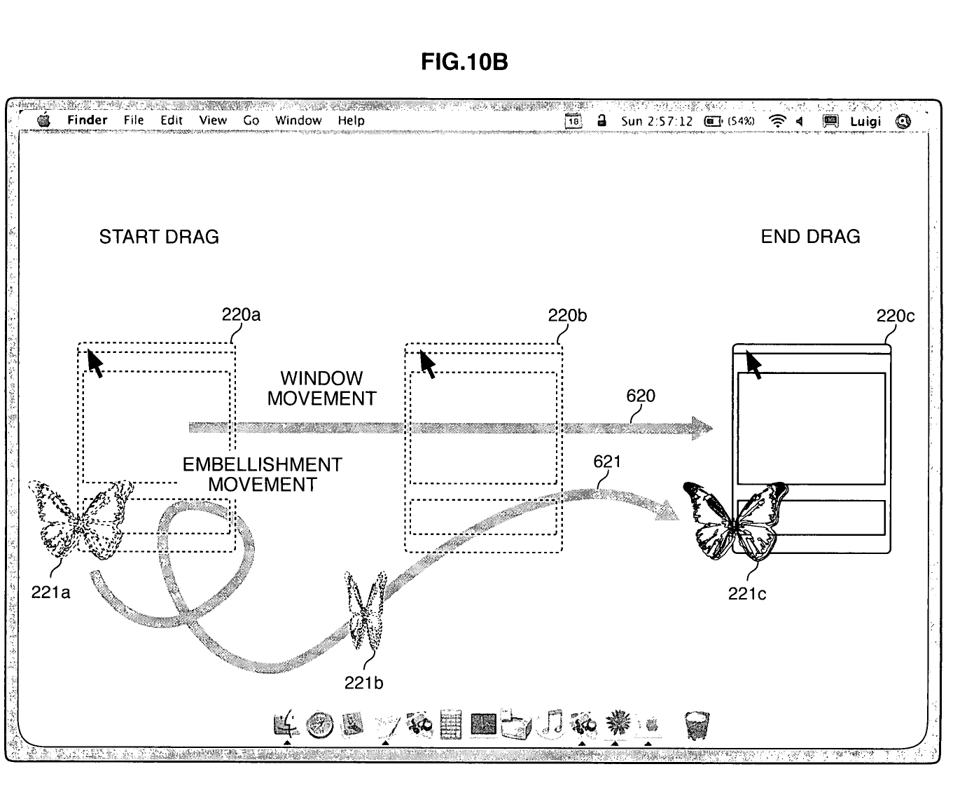

FIG. 10A provides an example for an embellishment that behaves as if it were “bonded” to its associated window during a user controlled repositioning of the associated window. In the example, both the window and the embellishment are represented in three successive time instances. The imaginary arrow 610 indicates the trajectory of the window during a user drag, and the imaginary arrow 611 indicates the trajectory of the embellishment also during the user drag.

In the first time instance, before the drag begins, the embellishment 211a, a butterfly, is located near the bottom left corner of the window 210a. In the second time instance, during the drag, the embellishment 211b, a butterfly, has its relative position to the associate window 210b unchanged, and it is noticeable that the embellishment 211b, a butterfly, is still located near the bottom left corner of the window 210b. In the third time instance, at the end of the drag, the embellishment 211c, a butterfly, has its relative position to the associate window 210c unchanged. It is noticeable that the embellishment 211c, a butterfly, is still located near the bottom left corner of the window 210c.

FIG. 10B provides an example for an embellishment that, during a user controlled repositioning of the associated window, becomes animated and loosely follows the associated window. In the example, both the window and the embellishment are represented in three successive time instances. The imaginary arrow 620 indicates the trajectory of the window during a user drag, and the imaginary arrow 621 indicates the trajectory of the embellishment also during the user drag.

In the first time instance, before the drag begins, the embellishment 221a, a butterfly, is located near the bottom left corner of the window 220a. In the second time instance, during the drag, the embellishment 221b, a butterfly, becomes animated (e.g. it is flapping its wings) and loosely follows (e.g. it performs a loop) the associated window 220b. It is noticeable that during the drag the embellishment 221b, a butterfly, has its relative position to the window 220b constantly altered. In the third time instance, at the end of the drag, the embellishment 221c, a butterfly, has its relative position to the associate window 220c restored to the original relative position it had before the drag started. It is noticeable that the embellishment 221c, a butterfly, is again located near the bottom left corner of the window 220c.

An embodiment may provide different types of embellishment “bonding” (e.g. “glued”, loosely follows, disappear and the reappear, etc.) with the associated window during, for example, the associated window repositioning or resizing. The type of “bonding” may be, for example, preset and different for each embellishment, upon embellishment type (e.g. flowers behave as “glued”, animals behave as loosely following, and people disappear and reappear), random, upon the day of the week, upon the time of the day, and upon user input (e.g. user preferences).

In one embodiment, upon digital system input, e.g. upon user request, an embellishment, for example, may be converted into, or may generate, a further embellishment, which typically is displayed temporarily (i.e. an alternate embellishment). Sometimes, an embellishment displays a scaled down version of a digital artwork, i.e. the digital artwork from which it is derived. Upon digital system input, the embellishment may be converted into, or might generate, an alternate embellishment displaying, for example, the digital artwork at full size. An animated transitional phase may be played, for example, to give a user the perception of a temporal and/or spatial connection between the embellishment and the alternate embellishment.

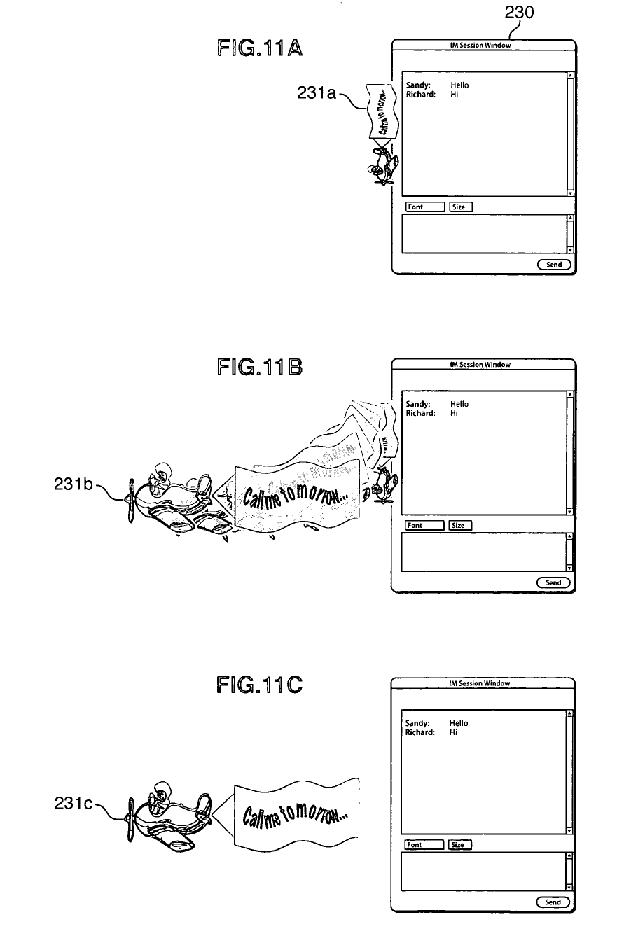

FIGS. 11A, 11B, and 11C provide an example of one embodiment wherein an embellishment is transitioning into an alternate form. In FIG. 11A an embellishment 231a, an airplane, is associated with the window 230. In FIG. 11B an animated transitional phase 231b is played. In FIG. 11C the original embellishment is no longer visible to the user, and the temporary alternate embellishment 231c, a larger airplane, is now visible. The embellishment 231c is displaying a larger, more suitable for viewing, representation of the digital artwork from which both, the embellishment 231a of FIG. 11A and the alternate embellishment 231c of FIG. 11C, are derived from.

One embodiment might store on a local digital system the data representing an embellishment. In such case, the embellishment may be displayed only on the digital system where the data is stored, e.g. a personal computer. One alternate embodiment might store the data representing an embellishment remotely on, for example, a server. In such case, the embellishment may be displayed on any digital system connect to the server, e.g. several personal computers.

In one embodiment, an embellishment may be associated with a graphical user interface element based on temporal rules. For example, an embellishment may be associated with a graphical user interface element on weekdays only, e.g. a picture overlaying a menu bar is displayed only from Monday through Friday, while on Saturday and Sunday another picture may be displayed.

In one embodiment, an embellishment may be regenerated (i.e. a new digital elaboration of the digital artwork is generated and displayed in place of the original digital artwork, or of a digital elaboration of it, for the purpose to have the embellishment present a display that is somewhat, or totally, different than before its regeneration). An embellishment may be regenerated upon input from the digital system, for example, automatically on a temporal basis (e.g. every day or at random), automatically in response to local or remote events (e.g. a new window is opened or an input from a server), or upon a user request.

In one embodiment, an application itself might be responsible for storing, handling, and displaying embellishments associated with its own graphical user interface elements. For example, an instant messenger application might allow a recipient user to create an embellishment from a digital artwork received from a sender user. Other examples are an e-mail application that allows a user to attach to its windows digital artworks received from e-mails sent by others, or a spreadsheet application that allows s user to attach embellishment to its worksheets.

Using Apple Computer Mac OS X as an example for an embodiment, one mean to implement embellishments at application level is to store the digital artworks used for embellishments in images encoded in PNG format (Portable Network Graphics). Preferably, but not necessarily, the image should include an alpha channel. The alpha channel is used to make the portions of the image that should not be displayed transparent. Consequently, a rectangular image having an alpha channel, and which image comprises, for example, a face and a background can be displayed showing only the face, while the background of the image is hidden. The result is the display of a cut-out image (in this example, the new shape of the image is the contour of the face). Examples of alpha channels images are the embellishment depicted in FIG. 3B.

Providing a digital artwork stored in PNG format, the following is an example of C++ implementation for embellishment handling. An application can call the function CreateEmbellishment specifying the target window to which the embellishment should be associated with and the position of the embellishment. The image stored in the file named “embellishment.png” will be displayed associated with the target window and will follow the movement of the associated target window when the target window is repositioned. In addition, the embellishment will change layer position accordingly to any change in layer position of the target window. Simple code that doesn't need to be exemplified herewith can be employed to reposition the embellishment when the associated window is resized or closed.

```
#include <Carbon/Carbon.h>
static OSStatus WinEvents (EventHandlerCallRef iCall, EventRef
iEvt, void * iData);
static OSStatus ViewEvents (EventHandlerCallRef iCall, EventRef
iEvt, void * iData);
static CGImageRef GetImageFromPNGFile (CFStringRef iName);
    ///////////////
  WindowRef CreateEmbellishment (WindowRef iTargetWin, Point
iWhere)
{
  IBNibRef nib;
  WindowRef win;
  HIViewRef view;
  WindowGroupRef group;
  CreateNibReference (CFSTR (“main”), & nib);
  // creates the window
  const EventTypeSpec kWinEvt [ ] =
    {{ kEventClassWindow, kEventWindowGetRegion }};
  CreateWindowFromNib (nib, CFSTR (“embellishment”), & win);
  InstallWindowEventHandler (win, WinEvents,
    GetEventTypeCount (kWinEvt), kWinEvt, win, NULL);
  // creates the view that will display the image
  const EventTypeSpec kViewEvt [ ] =
    {{ kEventClassControl, kEventControlDraw }};
  HIViewFindByID (HIViewGetRoot (win),
    kHIViewWindowContentID, & view);
  InstallControlEventHandler (view, ViewEvents,
    GetEventTypeCount (kViewEvt), kViewEvt, view, NULL);
  // makes the window transparent
  HIWindowChangeFeatures (win, 0, kWindowIsOpaque);
  ReshapeCustomWindow (win);
  // associates the embellishment window with the target window
  // thereafter the embellishment window will follow and behave
  // in accordance with the target window
  MoveWindow (win, iWhere.h, iWhere.v, true);
  SetWindowGroup (win, GetWindowGroup (iTargetWin));
  CreateWindowGroup (0, & group);
  SetWindowGroupParent (group, GetWindowGroup (iTargetWin));
  SetWindowGroup (iTargetWin, group);
  SetWindowGroup (win, group);
  ChangeWindowGroupAttributes (group,
    kWindowGroupAttrLayerTogether
    | kWindowGroupAttrMoveTogether
    | kWindowGroupAttrSharedActivation
    | kWindowGroupAttrHideOnCollapse, 0);
  ShowWindow (win);
  return win;
}
    ///////////////
static OSStatus WinEvents (EventHandlerCallRef iCall, EventRef
iEvt, void * iData)
{
  WindowRegionCode code;
  RgnHandle rgn;
  if (GetEventClass (iEvt) == kEventClassWindow
    && GetEventKind (iEvt) == kEventWindowGetRegion)
  {
    GetEventParameter (iEvt, kEventParamWindowRegionCode,
      typeWindowRegionCode, NULL, sizeof (code), NULL, & code);
    if (code == kWindowOpaqueRgn)
    {
      // tell the OS that embellishment window is transparent
      // and no rectangular frame should be displayed
      GetEventParameter (iEvt, kEventParamRgnHandle,
        typeQDRgnHandle, NULL, sizeof (rgn), NULL, & rgn);
      SetEmptyRgn (rgn);
      return noErr;
    }
  }
  return eventNotHandledErr;
}
    ///////////////
static OSStatus ViewEvents (EventHandlerCallRef iCall, EventRef
iEvt, void * iData)
{
  CGContextRef ctx;
  CGRect bounds;
  if (GetEventClass (iEvt) == kEventClassControl
    && GetEventKind (iEvt) == kEventControlDraw)
  {
    GetEventParameter (iEvt, kEventParamCGContextRef,
      typeCGContextRef, NULL, sizeof (CGContextRef),
      NULL, & ctx);
    HIViewGetBounds ((HIViewRef) iData, & bounds);
    // make the view transparent and draws the image
    CGContextClearRect (ctx, bounds);
    CGImageRef imageRef = GetImageFromPNGFile (
      CFSTR (“embellishment.png”));
    CGContextDrawImage (ctx, bounds, imageRef);
    CFRelease (imageRef);
    return noErr;
  }
  return eventNotHandledErr;
}
    ///////////////
static CGImageRef GetImageFromPNGFile (CFStringRef iName)
{
  CFURLRef url;
  CGDataProviderRef provider;
  CGImageRef image = NULL;
  url = CFBundleCopyResourceURL (CFBundleGetMainBundle ( ),
    iName, NULL, NULL);
  provider = CGDataProviderCreateWithURL (url);
  image = CGImageCreateWithPNGDataProvider (provider, NULL,
    true, kCGRenderingIntentDefault);
  CGDataProviderRelease (provider);
  CFRelease (url);
  return image;
}
```

In one embodiment, for example, an application, a software, or the operating system may automatically add alpha channel data to an image that lacks it, may provide a facility for a user to control the application of alpha channel data to an image, or may otherwise provide means to remove from display unwanted parts of an image.

In one embodiment, an application might implement embellishments within rectangular window containers, as exemplified in FIG. 4A, by modifying the above C++ code to create non-transparent windows. How to create non-transparent windows is well described in the documentation for the operating system. Also, in one embodiment, an application might implement embellishments within the associated window, as exemplified in FIG. 4A, by calling standard operating system functions for drawing images in a window. How to draw images in a window is well described in the documentation for the operating system.

Although the above example is coded for Apple Computer Mac OS X operating system, other operating systems, such as Microsoft Windows XP and Linux, have capabilities for supporting different level of embellishment embodiments.

In one embodiment, the operating system itself, or a software extension of it (e.g. a driver, a DLL, a rootkit, or a kext) might handle the operations relative to the storing, handling, and displaying of embellishments. In such embodiment, an application does not necessitate to be aware of embellishments, i.e. the developers of the application did not include in the application code to handle embellishments. In other words, since a typical application delegates to the operating system the handling of a window, e.g. opening, closing, moving, and resizing of a window, by calling the operating system functions to perform such operations, the operating system is aware of the application windows and can associate and handle embellishments for the application windows without requiring any task to be performed by the application. Similarly, the operating system might handle embellishments associated to other graphical user interface elements, e.g. menus and controls.

In one embodiment, the operating system itself, or a software extension of it (e.g. a driver, a DLL, a rootkit, or a kext) might provide functions for an application to call in order to simplify the storing, handling, and displaying of embellishments at application level. Such functions might allow an application to easily perform sophisticated handling of an embellishment, such as associating an embellishment to a window content or to an application operation (e.g. playing music or scrolling a page of text).

In one alternative embodiment, a software, e.g. an application, an operating system, a driver, an operating system extension, or a WDEF, might modify the shape of a window border so as to display an embellishment within the, typically expanded, window border, and thus create the illusion for a user that the embellishment is overlaid, or underlaid, to the window.

In one embodiment, a software capable to handle embellishments (e.g. an application, the operating system, a driver, or an extension to the operating system) has capability to exchange an embellishment from the digital system where it is running to another digital system running software capable to handle embellishments. This exchange may be direct (e.g. using a P2P communication, a TCP channel, or an FTP session) or intermediated by at least one server (e.g. using an HTTP server or a dedicated server). In other words, the software capable to handle the embellishments may have embedded network capabilities and does not require another software (e.g. an e-mail client, an instant messaging client, or a P2P client) in order to exchange embellishments.

In one embodiment, a user may exchange with at least one recipient user an embellishment by performing such operation from within a graphical user interface that a software capable to handle embellishments may provide, without requiring the user to employ a separate communication application (e.g. an e-mail client application or an instant messenger application) to exchange the embellishment. A recipient user, from within a graphical user interface that a software capable of handling embellishments may provide, may be notified of the exchange and, for example, be prompted to decide whether or not to accept the delivery of the exchanged embellishment.

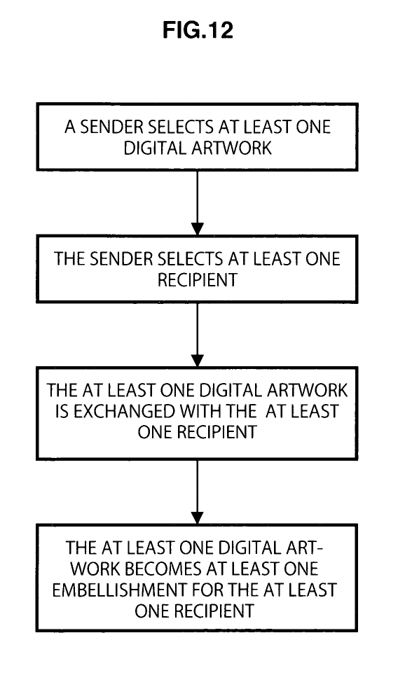

The flowchart of FIG. 12 is an example for a sequence of operations involving the selection of at least one digital artwork, the selection of at least one recipient user, and the delivery of the at least one digital artwork to the at least one recipient user. In one alternative embodiment, the selection of the at least one recipient user may be performed before the selection of the at least one digital artwork.

In one embellishment, a remote service, e.g. a web-site, may provide a sender user with a selection of digital artworks. The sender may select at least one digital artwork from the selection of digital artworks, and instruct the remote service to deliver the selected at least one digital artwork to at least one recipient user. If a recipient is known to the remote service to have software capable of handling embellishment available to the recipient's digital system, then the remote service may exchange the at least one digital artwork with the recipient's digital system by, for example, establishing a direct or intermediated connection with it.

In particular, the remote service, e.g. a web-site, may exchange the at least one digital artwork with the recipient's digital system without employing any user-controllable generic-communication software, e.g. an e-mail client or an instant message client. In such instance, the at least one digital artwork may be presented to the recipient user outside of the graphical user interface offered by a generic-communication software, for example, the at least one digital artwork may be displayed within a graphical user interface tailored to present digital artworks for embellishing. The recipient may be prompted whether or not he/she likes to receive the at least one digital artwork, for example, before the at least one digital artwork is displayed to him/her. A message (e.g. a caption) from, for example, the sender or the remote service may be delivered to the recipient along with the at least one digital artwork.

The remote service, e.g. a web-site, may be a closed service, meaning a service that is controlled exclusively by one or more trusted service providers only, instead of being open to a multitude of, for example, unregulated service providers. In such case, the likelihood of using digital artwork exchanges for spam purposes (i.e. unsolicited bulk communications) is greatly reduced to, possibly, zero.

In one embellishment, a remote service, e.g. a web-site, may provide a user with a selection of digital artworks. The user may select at least one digital artwork from the selection of digital artworks, and download the selected at least one digital artwork to his/her digital system to be used as embellishment.

In another embodiment, for example, a user may be allowed to browse other digital systems, wherein, for example, a software capable to handle embellishments is running, and to download selected embellishments from within a graphical user interface that a software capable to handle embellishments may provide on his/her digital system. In a further embodiment, for example, a user may send to at least one recipient user a message (e.g. an e-mail indicating the availability to download a specific embellishment or an e-mail comprising a specific embellishment) from within a graphical user interface that a software capable of handling embellishments may provide.

One embodiment may implement an interactive embellishment wherein, for example, a user action performed on an embellishment results in an action or task performed, for example, by the application which graphical user interface element the embellishment is associated with, by the operating system, or by other software. For example, a mouse click on an embellishment associated with a music application window may result in a command sent to the music application instructing the music application to start playing music or to select a particular playlist.

Although the invention is described herein with reference to specific embodiments, one skilled in the art will readily appreciate that other applications may be substituted for those set forth herein without departing from the spirit and scope of the present invention. In particular, although personal computer graphical user interfaces are used to describe the invention, the present invention is not limited to personal computers and it should be understood that the present invention covers any graphical user interface employing graphical user interface elements, such as, but not limited to, a graphical user interface for set-top boxes, game consoles, PDA's, and cellphones. Accordingly, the invention should only be limited by the Claims included below.

1. A computer implemented method, comprising the steps of:
rendering on a digital system a graphical user interface for a software;
said graphical user interface comprising at least one graphical user interface element, at least one graphical user interface element of said graphical user interface being accessible by a user of said graphical user interface;
said digital system having access to at least one digital artwork, and said user of said digital system selecting at least one digital artwork from said at least one digital artwork accessible by said digital system; and
said user of said digital system selecting at least one graphical user interface element from said graphical user interface to become embellished by said at least one digital artwork;
wherein said at least one digital artwork selected by said user becomes associated with said at least one graphical user interface element in the form of an embellishment of said at least one graphical user interface element, and the display of said embellishment becomes in relation to said at least one graphical user interface element display.

2. The method of claim 1, further comprising the step of:
said embellishment being partially overlaid, or underlaid, on said graphical user interface.

3. The method of claim 2, further comprising the step of:
said embellishment being displayed as cut-out image.

4. The method of claim 1, further comprising the step of:
said embellishment being displayed within a window partially overlaid, or underlaid, on said graphical user interface.

5. The method of claim 1, the selection of said at least one graphical user interface element happening before the selection of said at least one digital artwork by said user.

6. The method of claim 1, said relationship between said embellishment and said at least one graphical user interface element comprising any of the following:
said embellishment being displayed when said at least one graphical user interface element is displayed;
said embellishment being not displayed when said at least one graphical user interface element is not displayed;
said embellishment being displayed overlapping, partially overlapping, near, or about said at least one graphical user interface element;
said embellishment being displayed at a constant distance from said at least one graphical user interface element;
said embellishment following said at least one graphical user interface element when said at least one graphical user interface element is relocated within the display area of said graphical user interface;
said embellishment being displayed with the same, or a similar, graphical alteration applied to said at least one graphical user interface element;
said embellishment being displayed overlapping, partially overlapping, near, or about a portion of said at least one graphical user interface element; and
said embellishment being displayed at a constant distance from a portion of said at least one graphical user interface element.

7. The method of claim 1, said embellishment loosely following said associated at least one graphical user interface element during said associated at least one graphical user interface element repositioning or resizing.

8. The method of claim 1, wherein said at least one digital artwork selected by said user becomes associated with said at least one graphical user interface element in the form of an embellishment of said at least one graphical user interface element, and the display of said embellishment becomes in relation to said at least one graphical user interface element display and in relation to the content of at least one graphical user interface element.

9. The method of claim 1, wherein said at least one digital artwork selected by said user becomes associated with said at least one graphical user interface element in the form of an embellishment of said at least one graphical user interface element, and the display of said embellishment becomes in relation to said at least one graphical user interface element display and in relation to a performing of at least one task by at least one software.

10. The method of claim 1, the display of said embellishment being altered in response of any of the following:
input from data exchanged in a network communication;
input from said software;
input from another software;
input from the operating system;
input from a software extending the functionality of the operating system;
input from a software altering the functionality of the operating system;
expiration of a preset amount of time; and
a user operation on said user interface.

11. The method of claim 1, the display of said embellishment being animated in response of any of the following:
input from data exchanged in a network communication;
input from said software;
input from another software;
input from the operating system;
input from a software extending the functionality of the operating system;
input from a software altering the functionality of the operating system;
expiration of a preset amount of time; and
a user operation on said user interface.

12. The method of claim 1, said embellishment transitioning into, or generating, an alternative display of said embellishment.

13. The method of claim 1, said software being any of the following:
an instant messenger application;
an e-mail application;
a browser application;
a file viewer application;
a music application;
an accessory application; and
an office application.

14. The method of claim 1, said relationship being handled by any of the following:
said software;
a second software;
the operating system;
a software extending the functionality of the operating system; and
a software altering the functionality of the operating system.

15. The method of claim 1, said embellishment display being handled by any of the following:
said software;
a second software;
the operating system;
a software extending the functionality of the operating system; and
a software altering the functionality of the operating system.

16. The method of claim 1, said embellishment being altered in size and/or shape to match, approximate, or be in relation to the size and/or shape of at least one side of the border of said associated at least one graphical user interface element.

17. A computer implemented method, comprising the steps of:
rendering on a digital system a graphical user interface for a software;
said graphical user interface comprising at least one graphical user interface element, at least one graphical user interface element of said graphical user interface being accessible by a user of said graphical user interface;
receiving a communication from a sender that comprises at least one digital artwork to be displayed to the user of said digital system, said at least one digital artwork being selected by said sender;
said communication not involving a user selectable generic communication software;
said recipient selecting at least one digital artwork from said at least one digital artwork comprised in said communication; and
said user selecting at least one graphical user interface element from graphical user interface to become embellished by said at least one digital artwork selected by said user;
wherein said at least one digital artwork selected by said recipient becomes associated with said at least one graphical user interface element in the form of an embellishment of said at least one graphical user interface element, and the display of said embellishment becomes in relation to said at least one graphical user interface element display.

18. The method of claim 17, the selection of said at least one graphical user interface element happening before the selection of said at least one digital artwork by said user.

19. The method of claim 17, wherein said at least one digital artwork selected by said recipient becomes associated with said at least one graphical user interface element in the form of an embellishment of said at least one graphical user interface element, and the display of said embellishment becomes in relation to said at least one graphical user interface element display and in relation to the content of at least one graphical user interface element.

20. A computer implemented method, comprising the steps of:
rendering on a network capable digital system a communication application graphical user interface for communications involving at least one recipient and a sender;
said communication application graphical user interface comprising at least one graphical user interface element, at least one graphical user interface element of said communication application graphical user interface being accessible by said recipient;
receiving a communication that comprises at least one digital artwork to be displayed to said recipient, said at least one digital artwork being selected by said sender;
said recipient selecting at least one digital artwork from said at least one digital artwork comprised in said communication; and
said recipient selecting at least one graphical user interface element from said communication application graphical user interface to become embellished by said at least one digital artwork selected by said recipient;
wherein said at least one digital artwork selected by said recipient becomes associated with said at least one graphical user interface element in the form of an embellishment of said at least one graphical user interface element, and the display of said embellishment becomes in relation to said at least one graphical user interface element display.

21. The method of claim 20, the selection of said at least one graphical user interface element happening before the selection of said at least one digital artwork by said recipient.

22. The method of claim 20, wherein said at least one digital artwork selected by said recipient becomes associated with said at least one graphical user interface element in the form of an embellishment of said at least one graphical user interface element, and the display of said embellishment becomes in relation to said at least one graphical user interface element display and in relation to the content of at least one graphical user interface element.
